(19) United States
(12) Patent Application Publication
(10) Pub. No.: US 2025/0141277 A1
(43) Pub. Date: May 1, 2025

(54) METHOD TO MAKE IMPROVED ELECTRICAL STEELS

(71) Applicant: XEROX CORPORATION, Norwalk, CT (US)

(72) Inventor: Daniel Bullard, Conroe, TX (US)

(21) Appl. No.: 18/497,614

(22) Filed: Oct. 30, 2023

(51) Int. Cl. H02K 1/02; H02K 3/04; H02K 15/02; H02K 15/06

(52) U.S. Cl. CPC H02K 1/02; H02K 3/04; H02K 15/02; H02K 15/06

(57) ABSTRACT

An electrical core has a ferromagnetic material having discrete particles, the particles aligned in a unified crystallographic direction, a structural material holding the ferromagnetic material having the shape of a hollow rectangle, and a winding comprised of wires wound around the hollow rectangle to form a core. A method of producing an electrical core includes printing ferromagnetic particles in a shape of an electrical core, aligning the ferromagnetic particles to a unified crystallographic direction to produce aligned particles, depositing a structural material around the aligned particles to form a monolith with a center opening, and applying winding to finish the electrical core.

### TECHNICAL FIELD

This disclosure relates to transformer cores, rotors, and stators, more particularly to making substitute for electrical steel laminations.

### BACKGROUND

Motors, comprised of rotors and stators, consume 50% of the electricity in the US yearly. The average motor efficiency, across all motor sizes weighted by sales volume, is approximately 68%. The inefficiency results from core loss, and I²R loss by both the stator and the rotor, friction and winding loss, and stray load loss. I²R loss measures the efficiency of a component regarding power (V=IR, W=IV=IIR).

The loss from stators and rotors results from material limitations. Typically, these parts are stamped out of steel sheets in intricate shapes of 0.1 to 1.2 mm thick. These are then laminated together. Typically, a wire “winding” loops around the stack to form the coil that becomes part of the stator, rotor, or in the case of transformers, the core. New materials are needed to overcome the material limitations of the current components.

### SUMMARY

According to aspects illustrated here, there is provided an electrical core has a ferromagnetic material having discrete particles, the particles aligned in a unified crystallographic direction, a structural material holding the ferromagnetic material having the shape of a hollow rectangle, and a winding comprised of wires wound around the hollow rectangle to form a core.

According to aspects illustrated here, there is provided a method of producing an electrical core includes printing ferromagnetic particles in a shape of an electrical core, aligning the ferromagnetic particles to a unified crystallographic direction to produce aligned particles, depositing a structural material around the aligned particles to form a monolith with a center opening, and applying winding to finish the electrical core.

### BRIEF DESCRIPTION OF THE DRAWINGS

FIG. 1 shows an example of a currently available motor or transformer core laminations and a winding.

FIG. 2 shows an example of a motor.

FIG. 3 shows an embodiment of a core monolith.

FIG. 4 shows a flowchart of an embodiment of a method to produce a substitute for electrical steel.

### DETAILED DESCRIPTION OF THE EMBODIMENTS

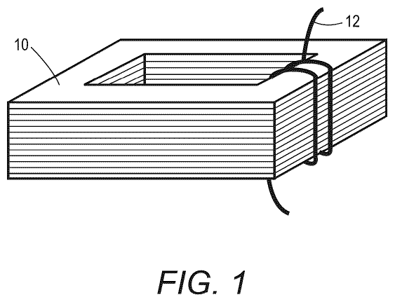

Embodiments here involve a monolithic structure usable as a replacement for rotors, stators, or transformer cores. For simplicity, this discussion here will refer to these as “cores.” In some instances, the term “core” in reference to motors means both the rotor and stator, but in this discussion, the core comprises Rotor, stator and transformer cores typically refers to the assembly of metal plates laminated together and then surrounded by wire loops, or “windings.” For purposes of discussion, the term “electrical core” as used here means the stack of thin plates, referred to as laminations, which form the structure surrounded by windings. FIG. 1 shows an example of an electrical core comprised of a stack 10 with a portion of a winding 12.

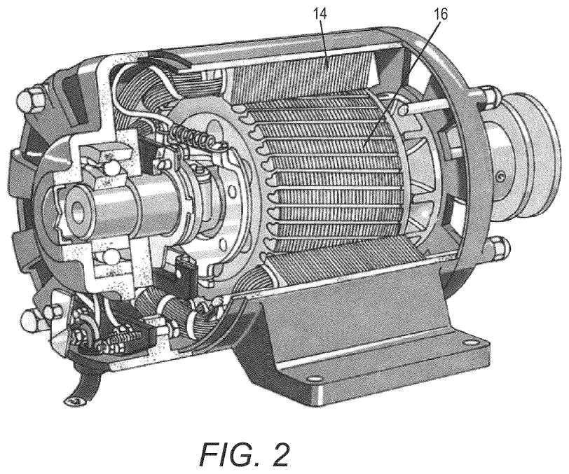

Motors typically have a rotor and a stator, where the rotor rotates within the stator. Both have cores. FIG. 2 shows an example of a motor with a stator 14 and a rotor 16. Another structure that includes these types of core stacks are transformers. The ability to replace these structures with a more efficient and easier to manufacture component would provide several advantages in terms of performance and costs.

Manufacture of the current cores involves fabricating thin sheets of steel, or iron, then cutting or stamping them into the needed shapes, stacking them, and then machining as needed the stack to achieve the required tolerances and balance the rotor.

Currently, three different materials are typically used in the core stack, steel, iron, and soft magnetic composites. Soft magnetic composites typically comprise powdered iron coated with an electrically insulative material. This may comprise coating the particles of the powder with the insulating material. The resulting material generally has low eddy current losses. However, these materials still have the losses discussed above.

In contrast, the electrical core of the embodiments does not consist of a stack of laminated sheets but instead comprises a solid, or monolithic, structure comprised of a structural material that includes ferromagnetic materials integrated within it. Some embodiments also include monoliths that have features to accommodate the wire of the winding.

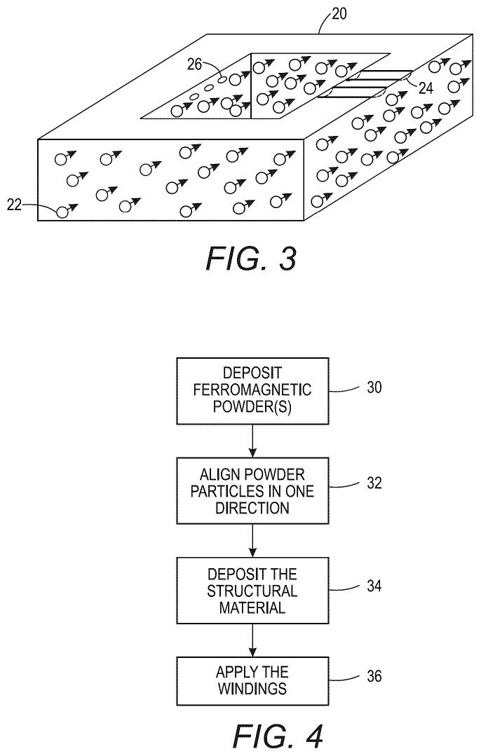

FIG. 3 shows an embodiment of an electrical core without its windings formed from a monolithic structure 20. The monolithic structure 20 may be just a solid rectangular piece with a center opening to accommodate the windings. The monolith contains magnetic material particles 20, such as the particles of iron powder. In contrast to soft magnetic composites, the particles in this monolith undergo alignment prior to the monolith material being deposited on the ferromagnetic particles.

The alignment occurs with application of a magnetic field that brings the 110 plane of the particles parallel to the surface, and the 001 crystal plane to face the direction of printing or casting. The alignment of the crystal plane is referred to as a unified crystallographic direction. As used here, reference to the particles aligning to the unified crystallographic direction means that a majority of the particles align to that direction. The ferromagnetic particles may comprise one or more of iron, iron silicide, and iron silicon aluminum, and may be polycrystalline. As will be discussed further, the deposition process may involve printing, extruding or die casting.

As will be discussed in more detail below, the monolith 20 may include features to accommodate the wires of the winding. FIG. 3 shows two examples. A first example comprises grooves such as 24, with the understanding that they may cover the entirety of the surface of the monolith. As the wire is wound around the monolith and through the center opening, the wires lie in the grooves. This eliminates voids between the wires in the windings and will make the gap between the monolith and the winding smaller. These improve the efficiency of the electrical core.

FIG. 4 shows an embodiment of a method of forming an electrical core. While the flow chart may imply an order of the processes, one should note that the depositing 30 and aligning 32 steps may occur as shown, in the reverse order, or even simultaneously. The ferromagnetic powders are deposited, such as by printing. If the structural material is to be die cast, the ferromagnetic powders may be printed into the die, as an example. The particles undergo magnetic alignment with application of a magnetic field at 32. This causes the particles to align their crystal faces as discussed above.

Once the powders are printing and aligned, or aligned and then printed, or possibly printed and aligned simultaneously, a structural material then locks the magnetic orientation into place and provides the supporting material to allow the structure to support windings. This structural material may comprise aluminum or a polymer binder, and the deposition at 34 may involve printing, die casting, or extruding the structural material onto the ferromagnetic particles to provide a matrix in which they reside. The electrical core is then finished by applying the winding.

Variations and modifications for this process exist. For example, depositing the structural material may involve printing the structural material in a matrix around the aligned particles. The structural material may comprise aluminum or other insulative metal. Depositing the structural material may comprise die casting the structural material, this may also involve using a negative die to leave grooves in a surface of the structural material. Depositing the structural material may comprise depositing the structural material such that holes are left in the structural material, this may involve a mold or other type of structure that forms the holes. Depositing the structural material comprises one of printing or die casting a polymer binder that will then solidify or cure to form the monolith.

Depending upon the structure of the monolith, applying the winding may take many forms. These may include winding wire around the monolith and through the center opening, winding wire around the monolith and through the center opening such that the wires lay in grooves in at least a top surface of the monolith, or winding wire through holes in the monolith.

In this manner, one can produce electrical cores formed of a monolith having a center opening to accommodate the windings. The monolith avoids the lengthy and exacting process of stamping or cutting multiple laminations, then stacking and machining them prior to applying the winding. The resulting electrical core of the embodiments will have less loss and therefore increased efficiency of those currently being used.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. An electrical core, comprising:
a ferromagnetic material having discrete particles, the particles aligned in a unified crystallographic direction;
a structural material holding the ferromagnetic material having the shape of a hollow rectangle; and
a winding comprised of wires wound around the hollow rectangle to form a core.

2. The electrical core as claimed in claim 1, wherein the electrical core has holes arranged in hollow rectangle to accommodate the wires.

3. The electrical core as claimed in claim 1, wherein the electrical core has grooves to accommodate the wires.

4. The electrical core as claimed in claim 1, wherein the structural material comprises aluminum.

5. The electrical core as claimed in claim 1, wherein the structural material comprises a polymer binder.

6. The electrical core as claimed in claim 1, wherein the structural material comprises aluminum.

7. The electrical core as claimed in claim 1, wherein the particles comprise one of iron, iron silicide, and iron silicon aluminum.

8. A method of producing an electrical core, comprising:
printing ferromagnetic particles in a shape of an electrical core;
aligning the ferromagnetic particles to a unified crystallographic direction to produce aligned particles;
depositing a structural material around the aligned particles to form a monolith with a center opening; and
applying winding to finish the electrical core.

9. The method as claimed in claim 8, wherein printing the ferromagnetic particles and aligning the ferromagnetic particles occurs one of simultaneously, printing and then aligning, and aligning and then printing.

10. The method as claimed in claim 8, wherein depositing the structural material comprises one of die casting, printing, or extruding the structural material.

11. The method as claimed in claim 8, wherein depositing the structural material comprises printing the structural material in a matrix around the aligned particles.

12. The method as claimed in claim 11, wherein printing the structural material comprises printing an aluminum matrix around the aligned particles.

13. The method as claimed in claim 8, where in depositing the structural material comprises die casting the structural material and using a negative die to leave grooves in a surface of the structural material.

14. The method as claimed in claim 8, wherein depositing the structural material comprises depositing the structural material such that holes are left in the structural material.

15. The method as claimed in claim 8, wherein depositing the structural material comprises one of printing or die casting a polymer binder

16. The method as claimed in claim 8, wherein applying winding comprises winding wire around the monolith and through the center opening.

17. The method as claimed in claim 8, wherein applying winding comprises winding wire around the monolith and through the center opening such that the wires lay in grooves in at least a top surface of the monolith.

18. The method as claimed in claim 8, wherein applying winding comprises winding wire through holes in the monolith.
